(19) United States
(12) Patent Application Publication
(10) Pub. No.: US 2013/0257146 A1
(43) Pub. Date: Oct. 3, 2013

(54) ELECTRIC VEHICLE SUPPLY EQUIPMENT FOR ELECTRIC VEHICLES

(71) Applicants: GERALDO NOJIMA, Asheville, NC (US); William E. Wilkie, Fletcher, NC (US)

(72) Inventors: GERALDO NOJIMA, Asheville, NC (US); William E. Wilkie, Fletcher, NC (US)

(21) Appl. No.: 13/438,002

(22) Filed: Apr. 3, 2012

(51) Int. Cl. B60L 1/00

(52) U.S. Cl. 307/9.1

(57) ABSTRACT

Electric vehicle supply equipment includes an alternating current to direct current converter having an alternating current input and a direct current output. A direct current bus is electrically interconnected with the direct current output of the alternating current to direct current converter. Each of a plurality of direct current to direct current converters includes an input powered by the direct current bus and an output structured to charge a corresponding one of a plurality of different electric vehicles.

### BACKGROUND

1. Field

The disclosed concept pertains generally to electric vehicles and, more particularly, to electric vehicle supply equipment, such as, for example, battery charging systems.

2. Background Information

An electric vehicle (EV) charging station, also called an EV charging station, electric recharging point, charging point, and EVSE (Electric Vehicle Supply Equipment), is an element in an infrastructure that supplies electric energy for the recharging of electric vehicles, plug-in hybrid electric-gasoline vehicles, or semi-static and mobile electrical units such as exhibition stands.

Many vehicles have provisions for receiving both alternating current (AC) and direct current (DC) power. Ultimately, all vehicle batteries are charged with DC power. However, the location of the power conversion equipment varies: (1) Level 1: 120 VAC power is supplied to the vehicle through AC EVSE, and conversion to DC for charging the batteries is made on board the vehicle; (2) Level 2: 240 VAC power is supplied to the vehicle through AC EVSE, and conversion to DC for charging the batteries is made on board the vehicle; and (3) DC Charging: DC power is supplied directly to the vehicle, the supply and power conversion is made outside the vehicle.

Known DC charging equipment requires a complete AC/DC conversion within a DC charger. For example, in a typical DC charger, AC is supplied to the DC charger, is rectified to DC, and subsequently goes through a DC-DC conversion (e.g., using an inverter, a transformer and a rectifier). This functionality is all contained within the same DC charger enclosure or “box”.

Typical electric vehicle charging is currently achieved with a dedicated complete charging unit per vehicle. Due to the emerging nature of this technology, the cost of infrastructure to support conversion to electric vehicles can present a barrier for adoption.

There is room for improvement in electric vehicle supply equipment.

### SUMMARY

For fleet or commercial multi-point charging stations, an opportunity exists to reduce the cost of charging equipment by optimizing the system design. This need and others are met by embodiments of the disclosed concept where each of a plurality of direct current to direct current converters comprises an input powered by a direct current bus and an output structured to charge a corresponding one of a plurality of different electric vehicles.

In accordance with one aspect of the disclosed concept, electric vehicle supply equipment comprises: an alternating current to direct current converter comprising an alternating current input and a direct current output; a direct current bus electrically interconnected with the direct current output of the alternating current to direct current converter; and a plurality of direct current to direct current converters, each of the direct current to direct current converters comprising an input powered by the direct current bus and an output structured to charge a corresponding one of a plurality of different electric vehicles.

Each of the direct current to direct current converters may be structured to communicate with the alternating current to direct current converter.

The alternating current to direct current converter may be structured to limit power consumed by the direct current to direct current converters from the alternating current to direct current converter.

As another aspect of the disclosed concept, electric vehicle supply equipment comprises: a first processor comprising a first communication interface; an alternating current to direct current converter comprising an alternating current input and a direct current output; a direct current bus electrically interconnected with the direct current output of the alternating current to direct current converter; and a plurality of direct current to direct current converters, each of the direct current to direct current converters comprising an input powered by the direct current bus, a second processor, a second communication interface, and at least one power unit controlled by the second processor and comprising an output structured to charge the corresponding one of the different electric vehicles, wherein the first communication interface is structured to communicate with the second communication interface, and wherein the first processor is structured to communicate a power threshold from at least one of an input from a utility and an input from a user, and to communicate a number of messages to the second processor of a corresponding number of the direct current to direct current converters to limit power output by the at least one power unit of the corresponding number of the direct current to direct current converters.

### BRIEF DESCRIPTION OF THE DRAWINGS

A full understanding of the disclosed concept can be gained from the following description of the preferred embodiments when read in conjunction with the accompanying drawings in which:

FIG. 1 is a block diagram of electric vehicle supply equipment in accordance with embodiments of the disclosed concept.

FIG. 2 is a block diagram of the electric vehicle supply equipment of FIG. 1 where one vehicle is charging and receives 100% of the requested power supplied with the charging capacity equal to the vehicle demand.

FIG. 3 is a block diagram of the electric vehicle supply equipment of FIG. 1 where two vehicles are charging and receive 100% of the requested power supplied with the charging capacity equal to the vehicle demands.

FIG. 4 is a block diagram of the electric vehicle supply equipment of FIG. 1 where three vehicles are charging and receive 50%, 60% and 70% of the requested power supplied with the charging capacity limited due to a demand reduction signal from a utility or by a user desire to limit peak charges.

FIG. 5 is a block diagram of the electric vehicle supply equipment of FIG. 1 showing communications between the AC-DC converter and the DC-DC converters.

FIG. 6 is a block diagram of a portion of the electric vehicle supply equipment of FIG. 1 showing the AC-DC converter and one of the DC-DC converters.

FIG. 7 is a plot of current versus state of charge for a battery being charged by the DC-DC converter of FIG. 6.

FIG. 8 is a block diagram in schematic form of the AC-DC converter and the DC-DC converter of FIG. 6.

FIG. 9 is a block diagram in schematic form of the controller and DC-DC converter of FIG. 6.

### DESCRIPTION OF THE PREFERRED EMBODIMENTS

As employed herein, the term “number” shall mean one or an integer greater than one (i.e., a plurality).

As employed herein, the term “processor” shall mean a programmable analog and/or digital device that can store, retrieve, and process data; a computer; a workstation; a personal computer; a controller; a microprocessor; a microcontroller; a microcomputer; a central processing unit; a mainframe computer; a mini-computer; a server; a networked processor; or any suitable processing device or apparatus.

As employed herein, the statement that two or more parts are “connected” or “coupled” together shall mean that the parts are joined together either directly or joined through one or more intermediate parts. Further, as employed herein, the statement that two or more parts are “attached” shall mean that the parts are joined together directly.

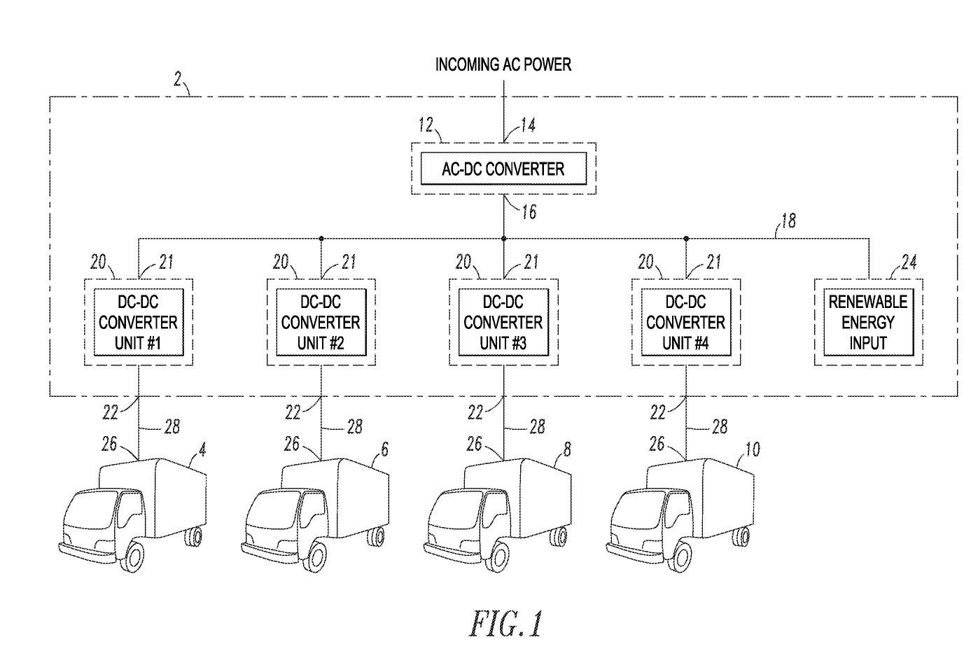

FIG. 1 shows electric vehicle supply equipment (EVSE) 2 for a plurality of electric vehicles, such as 4,6,8,10, in accordance with embodiments of the disclosed concept. The EVSE 2 includes an alternating current to direct current (AC-DC) converter 12 having an alternating current input 14 and a direct current output 16. A direct current bus 18 is electrically interconnected with the direct current output 16 of the AC-DC converter 12. Each of a plurality of direct current to direct current (DC-DC) converters 20 includes an input 21 powered by the DC bus 18 and an output 22 structured to charge a corresponding one of the different electric vehicles 4,6,8,10.

The cost (i.e., EVSE product cost and installation cost) of providing complete EVSE charging stations for each electric vehicle, such as 4,6,8,10, can be greatly reduced by consolidating the AC-DC conversion equipment (not shown) of prior electric vehicles (not shown) into the single AC-DC converter 12 supplying DC power via the distributed DC bus 18 and dispensing the DC power at the point of use with optimally sized DC-DC power converters 20. This approach differs from the known prior approach of supplying a complete AC-DC charging solution for each charging point since the initial stage of the power conversion at the AC-DC converter 12 is sized to accommodate the distributed load while the individual charging points at the DC-DC converters 20 are sized to accommodate the loading at each charging point.

### Example 1

The single AC-DC converter 12 creates the DC bus 18. An optional renewable energy power source 24 is electrically interconnected with and can independently power the DC bus 18. Each electric vehicle, such as 4,6,8,10, is associated with a corresponding one of the external DC-DC converters 20. The DC-DC converters 20 are not on board the electric vehicles 4,6,8,10, but rather are in a separate assembly. The electric vehicles 4,6,8,10 electrically connect to one of the DC-DC converters 20 to receive DC power. Each of the electric vehicles 4,6,8,10 is structured to receive the DC power from a corresponding one of the separate and distinct DC-DC converters 20.

### Example 2

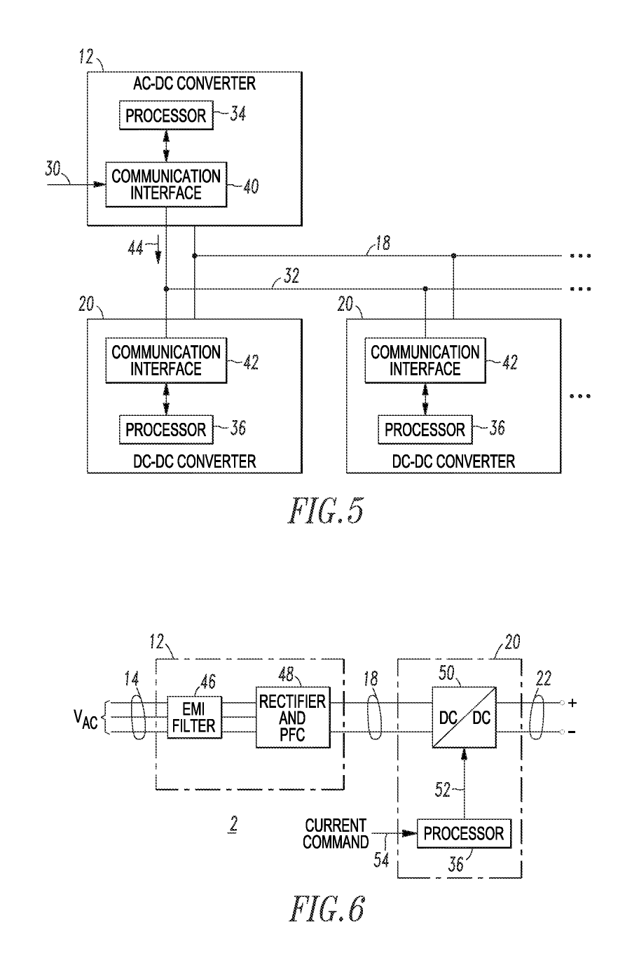

As will be discussed, below, in connection with FIGS. 5 and 6, there can be handshaking between a processor of each of the individual DC-DC converters 20 and a processor of the single AC-DC converter 12 or with another processor.

### Example 3

The AC-DC converter 12 is sized and structured to power all of the plurality of different electric vehicles 4,6,8,10. Although four example electric vehicles 4,6,8,10 and four example DC-DC converters 20 are shown, the disclosed concept is applicable to any suitable count of a wide variety of different electric vehicles and DC-DC converters. Each of the DC-DC converters 20 is sized and structured to power one of the different electric vehicles 4,6,8,10.

### Example 4

Each of the different electric vehicles 4,6,8,10 includes an input 26 structured to receive a DC voltage 28 from the output 22 of a corresponding one of the external DC-DC converters 20.

### Example 5

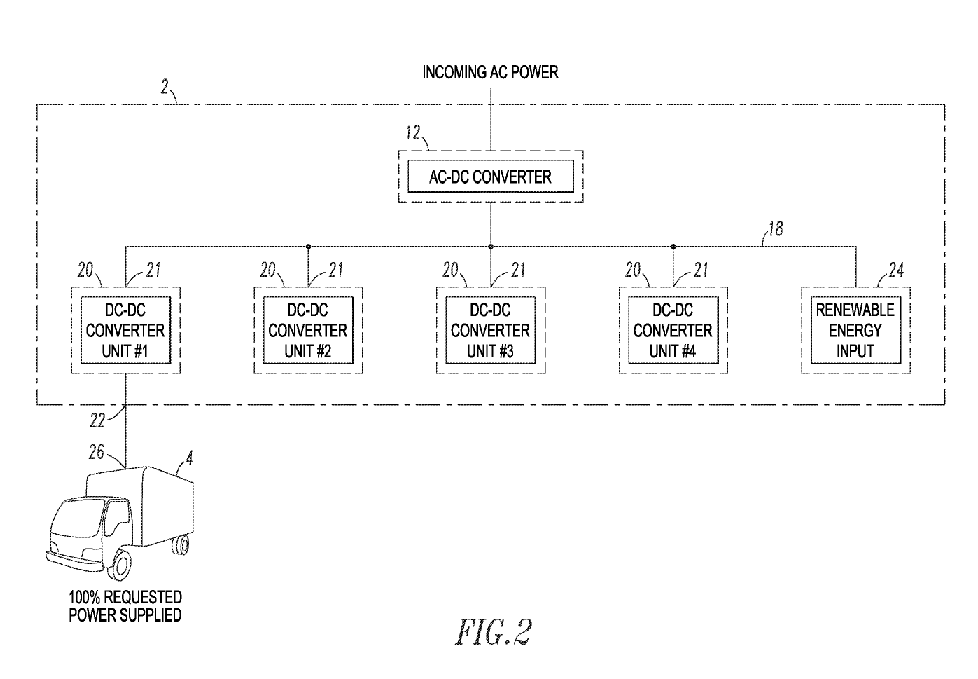

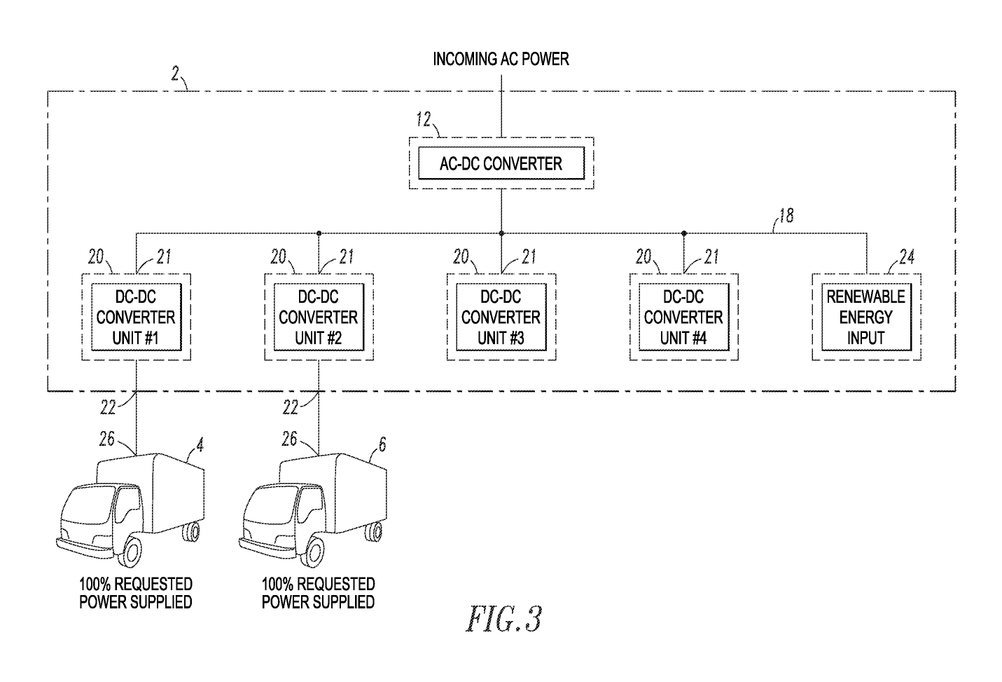

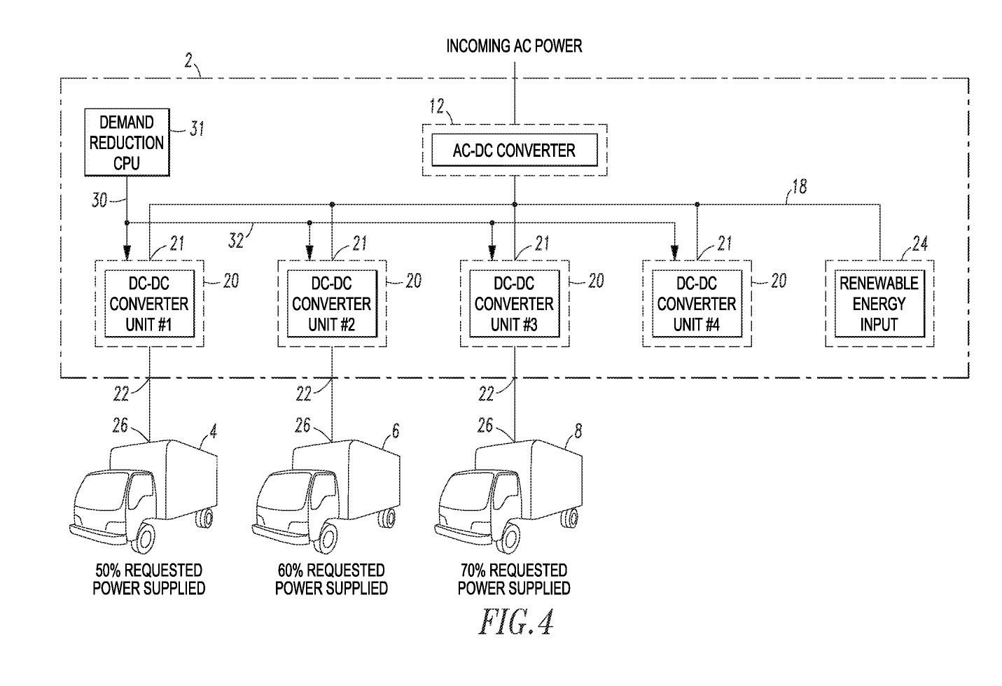

Referring to FIGS. 2-4, FIG. 2 shows one electric vehicle 4 is charging and receives 100% of the requested power supplied with the charging capacity equal to the vehicle demand FIG. 3 shows two vehicles 4,6 are charging and receive 100% of the requested power supplied with the charging capacity equal to the vehicle demands. FIG. 4 shows three vehicles 4,6,8 are charging and receive 50%, 60% and 70%, respectively, of the requested power supplied with the charging capacity limited due to a demand reduction signal 30 from a utility or from a user desiring to limit peak charges. The demand reduction signal 30 can be communicated in any suitable manner (e.g., without limitation, over a CAN bus).

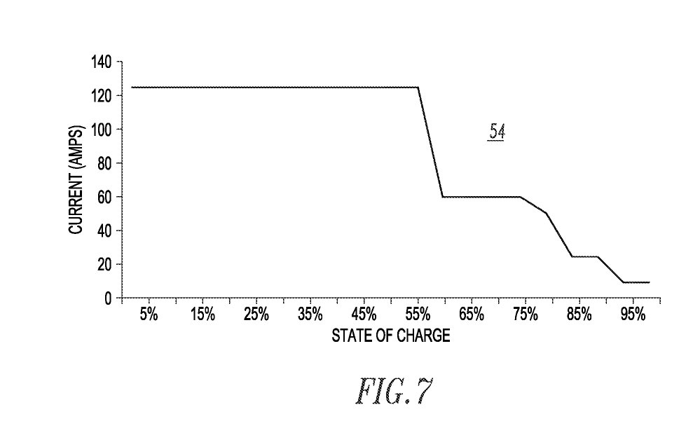

In FIGS. 2 and 3, one or two of the two electric vehicles 4,6 receive 100% of the power requested. In FIG. 4, the three different example percentages 50%, 60% and 70% reflect the percent of requested charge from the respective electric vehicles 4,6,8, not necessarily system capacity. Thus, they are not additive on a percentage basis. As will be described, the demand reduction signal 30 has the capability to limit the total power (e.g., kW) supplied to and by the combined DC-DC converters 20. Based on the reduced kW, the supply to each individual DC-DC converter 20 can be, for example and without limitation: (1) reduced by the same percentage amount as the demand reduction (e.g., without limitation, a utility requests a 50% reduction over a CAN bus and each DC-DC converter 20 causes the current provided to the corresponding electric vehicle to drop by 50%); (2) customized based on the state of the electric vehicle battery charge (e.g., without limitation, a corresponding flat reduction across the board for each DC-DC converter 20); (3) based on a user preference/priority (e.g., without limitation, charging can be prioritized based on user preferences); or (4) a master CPU 31 at a suitable location (e.g., without limitation, the AC-DC converter 12; another location) makes decisions knowing the states of the battery charge for all the DC-DC converters 20 (e.g., without limitation, the initial time frame for charging consumes the largest amount of energy as shown in FIG. 7) and knowing user preferences/priorities for shedding electric vehicles (e.g., for four example electric vehicles 4,6,8,10, first shed 10, then shed 8, and so on until the desired demand reduction is achieved).

If the example master CPU 31 is at the AC-DC converter 12, then the desired power threshold can be maintained for the common DC bus 18. The individual DC-DC converters 20 can be tied together on a control and communication bus network, such as 32, in which the master CPU 31 provides the logic and associated priority for dispensing power.

The master CPU 31 can respond to an external command (e.g., without limitation, a utility company signal via, for example, cellular; power line carrier; radio). This could control or maintain the desired power level by adjusting the maximum power level on the common DC bus 18. If the preset maximum kW is 100 kW, for example and without limitation, and if the demand was 125 kW, then there would be a common reduction of 20%.

### Example 6

A user desire to limit peak charges can affect the single AC-DC converter 12 and the multiple DC-DC converters 20. Suppose, for example, that a user wanted to limit the amount of power in any given 15 minute period in an attempt to minimize demand charges. A similar approach as disclosed in Example 5 could be employed. The only difference would be the threshold or demand reduction signal 30 is set by the user and is not driven by an external signal from a utility.

### Example 7

The disclosed concept differs from the known prior proposal of supplying a complete charging solution for each charging point since the initial stage of the power conversion is sized to accommodate the distributed load with the single AC-DC converter 12, while the charging points of the individual DC-DC converters 20 are sized to accommodate the loading at each charging point and supply DC directly to the battery (not shown) of the corresponding one of the electric vehicles 4,6,8,10.

The DC-DC converters 20 are cheaper than AC-DC converters, and the cost of one relatively large AC-DC converter 12 is effectively spread over many electric vehicles, such as 4,6,8,10. Hence, the intent is to spread the one AC-DC converter 12 over relatively many electric vehicles. It is expected that: (1) consolidating the AC-DC conversion into one unit is less expensive than providing for each individual charging point; and (2) the installation cost for providing one AC supply versus relatively many is expected to reduce installation cost.

There is the one AC-DC converter 12 that creates the constant voltage common DC bus 18. Then, there are multiple isolated DC-DC converters 20 that take the constant DC voltage off of the common DC bus 18. Each of the DC-DC converters 20 generates a galvanically isolated (from the common DC bus 18) battery charging voltage 28.

### Example 8

FIG. 5 shows communications between the AC-DC converter 12 and the DC-DC converters 20. The power conversion functionality of the AC-DC converter 12 and the isolated DC-DC converters 20 is done by their respective processors (e.g., controllers 34,36), which can employ suitable data and signal handshaking therebetween. Each of the isolated DC-DC converters 20 has a maximum output power limit parameter that can be set by an external device (e.g., without limitation, by a master CPU) that can receive messages from a utility company (e.g., without limitation, the demand reduction signal 30 from a utility company that defines the available power) and has a suitable algorithm to distribute the available power to the various DC-DC converters 20 connected to the common DC bus 18. This master CPU can be the one that controls the functions of the AC-DC converter 12, or can be separately located.

As shown in FIG. 5, each of the DC-DC converters 20 is structured to communicate with the AC-DC converter 12. When the master CPU is the processor (e.g., controller 34) of the AC-DC converter 12, the AC-DC converter 12 can limit power consumed by the DC-DC converters 20 from the AC-DC converter 12. For example, the AC-DC converter 12 includes a processor (e.g., controller 34) and a communication interface 40, and each of the DC-DC converters 20 includes a communication interface 42 structured to communicate with the communication interface 40 of the AC-DC converter 12. The AC-DC converter 12 is further structured to input a power threshold, such as the demand reduction signal 30 from a utility company or from an input from a user, and to communicate the power threshold to the DC-DC converters 20.

The AC-DC communication interface 40 communicates with the DC-DC communication interface 42. The AC-DC processor 34 communicates the demand reduction signal 30, which can be a power threshold from at least one of an input from a utility and an input from a user, and communicates a number of messages 44 to the DC-DC processor 36 of a corresponding number of the DC-DC converters 20 to limit power output by those converters 20.

Each of the DC-DC converters 20 is structured to reduce power output to its output 22 (FIGS. 1-4) based upon the demand reduction signal 30. For example, if the AC-DC converter 12 has an output power capacity (e.g., without limitation, a predetermined amount of kW), then it can communicate a command to each of the DC-DC converters 20 to reduce power output to the output 22 by: (a) the output power capacity times (b) one minus the power threshold. For example and without limitation, if the AC-DC converter 12 has a 250 kW maximum output power capacity, each of the DC-DC converters 20 has a 50 kW maximum output power capacity, a demand reduction signal is received with a maximum draw of 125 kW, then under normal circumstances, each DC-DC converter 20 would supply 50 kW to each vehicle battery based upon the state of the charge. The supply of power can be distributed by a flat percentage reduction (50%=125 kW/250 kW maximum; or a 50 kW×(1-50%) reduction=a 25 kW reduction) to each DC-DC converter 20 (Table 1, Example 10), or can be cascaded (Table 2, Example 11) based on priority charging that enables one or multiple vehicles 4,6,8,10 to reach full charge faster than a flat percentage reduction since the charging profiles for various batteries differ (see, e.g., FIG. 7).

### Example 9

The disclosed DC-DC converters 20 are employed for battery charging. Hence, they are current controlled or current sources with a controlled output voltage, in order that the maximum battery voltage is not exceeded. Being current controlled, these DC-DC converters 20 will output only a commanded current at a given output voltage range. For a given vehicle type, the battery voltage from discharged to fully charged is not very wide, but the maximum charging power is defined at the discharged battery voltage and the maximum current that the DC-DC current source converter 20 can output. For example and without limitation, a known battery goes from about 330 VDC discharged to about 362 VDC fully charged.

When, for example, a utility company sends a demand reduction signal, such as 30, thereby providing the EVSE 2 a certain power limit, a processor (e.g., without limitation, the AC-DC converter processor 34; another suitable processor; a master CPU) receives that signal and does one of the following: (1) limits the maximum output power of each DC-DC current source converter 20 equally such that the sum of the power for all of the DC-DC converters 20 is equal to or less than the utility commanded power limit; (2) arbitrarily distributes the allowed power budget to the connected DC-DC current source converters 20 according to a suitable priority; or (3) gives the maximum power if there is only a limited number of electric vehicles, such as 4 and 6 of FIG. 3, as long as the total charging power does not exceed the maximum output power, and if more electric vehicles, such as 8 of FIG. 4, would start charging, then the output power limit would become the same or would be suitably limited for each of the DC-DC converters 20.

### Example 10

Table 1, below, shows a flat demand reduction across all DC-DC converters 20 based upon an example 50% reduction. This assumes a 20 kWh battery. The initial current (62.5 A) and battery voltage (400 VDC) provide an initial energy of 6.25 kWh for the first 0.25 h (15 minutes). The total power is 6.25 kWh/0.25 h×5 units=125 kW. Similarly, the current (15 A) and battery voltage (400 VDC) for minutes 60 to 75 provide an energy of 1.5 kWh. The total power is 1.5 kWh/0.25 h×5 units=30 kW.

TABLE 1

| Time | Unit #1 | | Unit #2 | | Unit #3 | | Unit #4 | | Unit #5 | | Total |
|---|---|---|---|---|---|---|---|---|---|---|---|
| Period | Current | kWh | Current | kWh | Current | kWh | Current | kWh | Current | kWh | (kW) |
| 0-15 | 62.5 | 6.25 | 62.5 | 6.25 | 62.5 | 6.25 | 62.5 | 6.25 | 62.5 | 6.25 | 125 |
| 15-30 | 62.5 | 6.25 | 62.5 | 6.25 | 62.5 | 6.25 | 62.5 | 6.25 | 62.5 | 6.25 | 125 |
| 30-45 | 40 | 4 | 40 | 4 | 40 | 4 | 40 | 4 | 40 | 4 | 80 |
| 45-60 | 20 | 2 | 20 | 2 | 20 | 2 | 20 | 2 | 20 | 2 | 40 |
| 60-75 | 15 | 1.5 | 15 | 1.5 | 15 | 1.5 | 15 | 1.5 | 15 | 1.5 | 30 |
| Sum | | 20 | | 20 | | 20 | | 20 | | 20 | |

### Example 11

Table 2, below, shows that priority charging is given to units #1 and #2 in lieu of distributing power equally as in Table 1, above. The initial current (125 A) and battery voltage (400 VDC) provide an initial energy of 12.5 kWh for the first 0.25 h (15 minutes). The total power is 31 kWh/0.25 h for the first three units=124 kW. Similarly, the current (25 A total) and battery voltage (400 VDC) for minutes 60 to 75 provide an energy of 2.5 kWh total for units #4 and #5. The total power is 2.5 kWh/0.25 h for the two units=10 kW.

TABLE 2

| Time | Unit #1 | | Unit #2 | | Unit #3 | | Unit #4 | | Unit #5 | | Total |
|---|---|---|---|---|---|---|---|---|---|---|---|
| Period | Current | kWh | Current | kWh | Current | kWh | Current | kWh | Current | kWh | (kW) |
| 0-15 | 125 | 12.5 | 125 | 12.5 | 60 | 6 | 0 | 0 | 0 | 0 | 124 |
| 15-30 | 50 | 5 | 50 | 5 | 100 | 10 | 100 | 10 | 10 | 1 | 124 |
| 30-45 | 25 | 2.5 | 25 | 2.5 | 30 | 3 | 60 | 6 | 125 | 12.5 | 106 |
| 45-60 | | 0 | | 0 | 10 | 1 | 30 | 3 | 50 | 5 | 36 |
| 60-75 | | 0 | | 0 | | | 10 | 1 | 15 | 1.5 | 10 |
| Sum | | 20 | | 20 | | 20 | | 20 | | 20 | |

Preferably, the DC-DC converters 20 can input the state of battery charge for the corresponding different electric vehicles 4,6,8,10, and communicate the same to the AC-DC converter 12. In turn, the AC-DC converter 12 is further structured to input a power threshold, to input the state of battery charge of each of the different electric vehicles 4,6,8,10, and to communicate a command to a selected number of the DC-DC converters 20 to reduce power output to the output 22 for a number of the different electric vehicles 4,6,8,10 having the lowest state of battery charge until power output to the DC bus 18 is less than or equal to the power threshold.

Otherwise, if the DC-DC converters 20 cannot input the state of battery charge for the corresponding different electric vehicles 4,6,8,10, the AC-DC converter 12 is further structured to input a power threshold, to input a priority of each of the different electric vehicles 4,6,8,10, and to communicate a command to a selected number of the DC-DC converters 20 to reduce power output to the output 22 for a number of the different electric vehicles 4,6,8,10 having the lowest priority until power output to the DC bus 18 is less than or equal to the power threshold.

The AC-DC converter 12 can advantageously consider at least one of the priority and the state of battery charge for the corresponding different electric vehicles 4,6,8,10 along with the input power threshold when communicating commands to a selected number of the DC-DC converters 20 to reduce power output to the output 22.

### Example 12

FIG. 6 shows a portion of the electric vehicle supply equipment 2 of FIG. 1 including the AC-DC converter 12 and one of the DC-DC converters 20. The AC-DC converter 12 includes the AC input 14 (V_{AC}), an EMI filter 46 and a rectifier and power factor correction (PFC) circuit 48. The DC-DC converter 20 includes a DC/DC circuit 50 and the processor 36 providing current control 52 to the DC/DC circuit 50 responsive to a current command 54.

### Example 13

FIG. 7 is a non-limiting example plot of current versus state of charge for an electric vehicle battery (not shown) being charged by the DC-DC converter 20 of FIG. 6. The battery charging current is at a relatively high level for roughly the first half of the charging cycle before reducing, as shown.

### Example 14

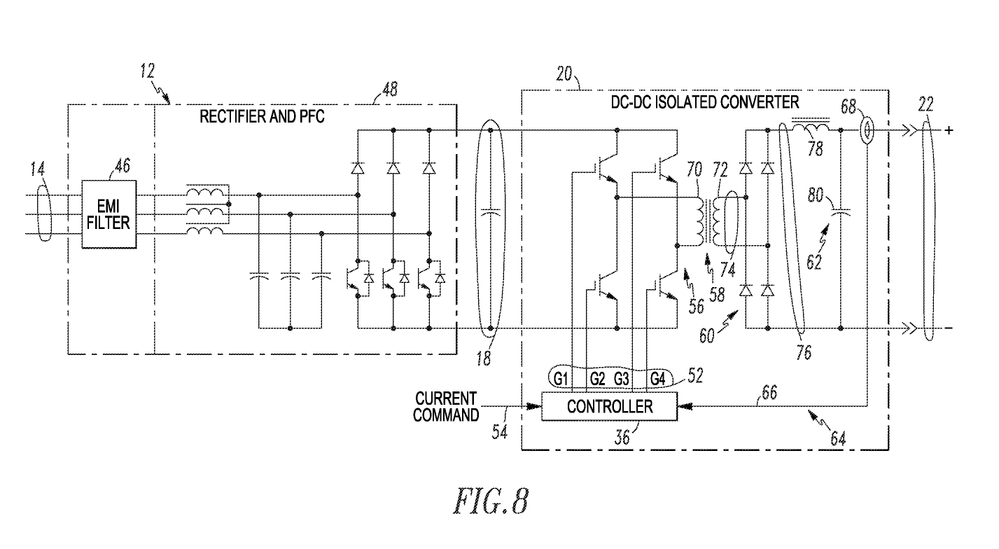

FIG. 8 shows more detail of the example AC-DC converter 12 and the example DC-DC converter 20 of FIG. 6. The DC-DC converter 20 includes an inverter 56, a transformer 58, a rectifier 60 and a filter 62. The inverter 56, the transformer 58, the rectifier 60 and the filter 62 form a single power unit 64. Although only one example power unit 64 is shown, the DC-DC converter 20 can advantageously employ a plurality of parallel power units (not shown) in order to increase the current capacity of the DC output 22. For simplicity of illustration, the example communication interface 42 of FIG. 5 is not shown. The controller 36 provides the current control 52 to the inverter 56 in the form of four gate signals G1,G2,G3,G4 based upon current feedback 66 from an output current sensor 68 and the current command 54.

The transformer 58 includes a primary winding 70 powered by the inverter 56 and a secondary winding 72. The rectifier 60 includes an input 74 powered by the secondary winding 72 and an output 76. The example filter 62 includes an inductor 78, a capacitor 80 and the output 22.

The controller 36 can control the inverter 56 to limit power consumed by the example DC-DC isolated converter 20 from the AC-DC converter 12, in order to provide a percentage or a priority based reduction in unit power output, as disclosed herein.

### Example 15

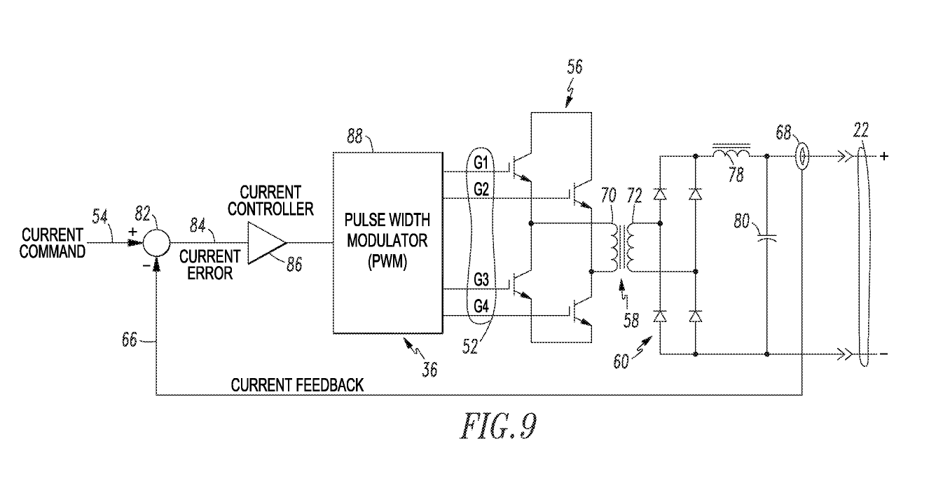

FIG. 9 shows the controller 36 and DC-DC converter 20 of FIG. 6. The example controller 36 can be implemented in any suitable analog and/or digital and/or processor-based circuit. The current command 54 can be analog (e.g., without limitation, 4-20 mA; 0-10 V; a signal of local origin; a signal of remote origin). The controller 36 subtracts, at 82, the current feedback 66 from the current command 54 to provide a current error signal 84. The controller 36 employs a suitable current controller 86 (e.g., PID; PI) and a pulse width modulator (PWM) 88 to output the current control gate signals G1,G2,G3,G4 to the inverter 56.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. Electric vehicle supply equipment comprising:
an alternating current to direct current converter comprising an alternating current input and a direct current output;
a direct current bus electrically interconnected with the direct current output of said alternating current to direct current converter; and
a plurality of direct current to direct current converters, each of said direct current to direct current converters comprising an input powered by said direct current bus and an output structured to charge a corresponding one of a plurality of different electric vehicles.

2. The electric vehicle supply equipment of claim 1 wherein said alternating current to direct current converter is sized and structured to power all of said plurality of different electric vehicles.

3. The electric vehicle supply equipment of claim 1 wherein said each of said direct current to direct current converters is sized and structured to power one of said different electric vehicles.

4. The electric vehicle supply equipment of claim 1 wherein the corresponding one of the different electric vehicles includes an input structured to receive a direct current voltage from the output of a corresponding one of said direct current to direct current converters.

5. The electric vehicle supply equipment of claim 4 wherein the corresponding one of said direct current to direct current converters is external to the corresponding one of the different electric vehicles.

6. The electric vehicle supply equipment of claim 1 wherein said direct current bus is further electrically interconnected with a renewable energy power source to independently power said direct current bus.

7. The electric vehicle supply equipment of claim 1 wherein each of said direct current to direct current converters is structured to communicate with said alternating current to direct current converter.

8. The electric vehicle supply equipment of claim 7 wherein said alternating current to direct current converter is structured to limit power consumed by said direct current to direct current converters from said alternating current to direct current converter.

9. The electric vehicle supply equipment of claim 8 wherein said alternating current to direct current converter is further structured to input a power threshold from at least one of an input from a utility and an input from a user, and to communicate said power threshold to said direct current to direct current converters.

10. The electric vehicle supply equipment of claim 8 wherein said alternating current to direct current converter is further structured to input a demand reduction signal, and to communicate said demand reduction signal to said direct current to direct current converters; and wherein each of said direct current to direct current converters is structured to reduce power output to said output structured to charge the corresponding one of the different electric vehicles based upon said demand reduction signal.

11. The electric vehicle supply equipment of claim 8 wherein said alternating current to direct current converter is further structured to input a demand reduction signal, and at least one of a state of battery charge of each of the different electric vehicles and a priority of each of the different electric vehicles, and to communicate a command to a selected number of said direct current to direct current converters to reduce power output to said output structured to charge the corresponding one of the different electric vehicles for a number of the different electric vehicles based on the demand reduction signal and said at least one of the state of battery charge of each of the different electric vehicles and the priority of each of the different electric vehicles.

12. The electric vehicle supply equipment of claim 8 wherein said alternating current to direct current converter is further structured to input a power threshold, to input a state of battery charge of each of the different electric vehicles, and to communicate a command to a selected number of said direct current to direct current converters to reduce power output to said output structured to charge the corresponding one of the different electric vehicles for a number of the different electric vehicles having the lowest state of battery charge until power output to said direct current bus is less than or equal to said power threshold.

13. The electric vehicle supply equipment of claim 8 wherein said alternating current to direct current converter is further structured to input a power threshold, to input a priority of each of the different electric vehicles, and to communicate a command to a selected number of said direct current to direct current converters to reduce power output to said output structured to charge the corresponding one of the different electric vehicles for a number of the different electric vehicles having the lowest priority until power output to said direct current bus is less than or equal to said power threshold.

14. The electric vehicle supply equipment of claim 8 wherein said alternating current to direct current converter has an output power capacity and is further structured to input a power threshold, and to communicate a command to each of said direct current to direct current converters to reduce power output to said output structured to charge the corresponding one of the different electric vehicles by: the output power capacity times one minus the power threshold.

15. The electric vehicle supply equipment of claim 1 wherein each of said direct current to direct current converters comprises at least one power unit comprising an input electrically connected to said direct current bus, an inverter powered by the last said input, a transformer comprising a primary winding powered by said inverter and a secondary winding, a rectifier comprising an input powered by said secondary winding and an output, and a filter for the output of said rectifier, said filter comprising the output structured to charge the corresponding one of the different electric vehicles.

16. The electric vehicle supply equipment of claim 15 wherein said at least one power unit further comprises a processor structured to control said inverter to limit power consumed by the corresponding one of said direct current to direct current converters from said alternating current to direct current converter.

17. The electric vehicle supply equipment of claim 16 wherein said alternating current to direct current converter further comprises a processor and a communication interface; and wherein said at least one power unit further comprises a communication interface structured to communicate with the communication interface of said alternating current to direct current converter.

18. Electric vehicle supply equipment comprising:
a first processor comprising a first communication interface;
an alternating current to direct current converter comprising an alternating current input and a direct current output;
a direct current bus electrically interconnected with the direct current output of said alternating current to direct current converter; and
a plurality of direct current to direct current converters, each of said direct current to direct current converters comprising an input powered by said direct current bus, a second processor, a second communication interface, and at least one power unit controlled by said second processor and comprising an output structured to charge the corresponding one of the different electric vehicles,
wherein said first communication interface is structured to communicate with said second communication interface, and
wherein said first processor is structured to communicate a power threshold from at least one of an input from a utility and an input from a user, and to communicate a number of messages to the second processor of a corresponding number of said direct current to direct current converters to limit power output by the at least one power unit of the corresponding number of said direct current to direct current converters.
